(19) United States
(12) Patent Application Publication
(10) Pub. No.: US 2018/0111489 A1
(43) Pub. Date: Apr. 26, 2018

(54) Circuit Arrangement and a Method of Operating a Circuit Arrangement for a System for Inductive Power Transfer

(71) Applicant: Bombardier Primove GmbH, Berlin (DE)

(72) Inventor: Robert Czainski, Doluje (PL)

(21) Appl. No.: 15/568,318

(22) PCT Filed: Apr. 22, 2016
(86) PCT No.: PCT/EP2016/058959

§ 371 Date: Oct. 20, 2017

(30) Foreign Application Priority Data
Apr. 23, 2015 (GB) 1506935.4

(51) Int. Cl. B60L 11/18; H02J 50/10; H01F 27/38; H01F 38/14

(52) U.S. Cl. CPC B60L 11/182; H02J 50/10; H02J 7/025; H01F 38/14; B60L 2210/40; H01F 27/38

(57) ABSTRACT

A circuit arrangement for a system for inductive power transfer and a method of operating a circuit arrangement, wherein the circuit arrangement includes at least one winding structure with a first and at least one other subwinding structure, wherein the subwinding structures are operatable in a first operational mode and a second operational mode, wherein an unipolar alternating electromagnetic field is providable in the first operational mode and a multipolar electromagnetic field is providable in the second operational mode.

The invention relates to a circuit arrangement and a method of operating a circuit arrangement for a system for inductive power transfer.

Electric vehicles, in particular a track-bound vehicle, and/or a road automobile, can be operated by electric energy which is transferred by means of an inductive power transfer. Such a vehicle may comprise a circuit arrangement, which can be a traction system or a part of a traction system of the vehicle, comprising a receiving device adapted to receive an alternating electromagnetic field and to produce an alternating electric current by electromagnetic induction. Furthermore, such a vehicle can comprise a rectifier adapted to convert an alternating current (AC) to a direct current (DC). The DC can be used to charge a traction battery or to operate an electric machine. In the latter case, the DC can be converted into an AC by means of an inverter.

The inductive power transfer is performed using two sets of winding structures. A first set is installed on the ground (primary winding structures) and can be fed by a wayside power converter (WPC). The second set of windings (secondary winding structures) is installed on the vehicle. For example, the second set of windings can be attached underneath the vehicle, in the case of trams under some of its wagons. For an automobile it can be attached to the vehicle chassis. The secondary winding structure(s) or, generally, the secondary side is often referred to as pick-up-arrangement or receiver or is a part thereof. The primary winding structure(s) and the secondary winding structure(s) form a high frequency transformer to transfer electric energy to the vehicle. This can be done in a static state (when there is no movement of the vehicle) and in a dynamic state (when the vehicle moves).

Different manufacturers of inductive power transfer systems, in particular of primary and secondary winding structure, exist. These manufactures provide different topologies and/or layouts of primary and secondary winding structures.

Some embodiments provide a one-phase topology on the primary side, wherein other embodiments provide a three-phase topology.

Further, different layouts of the winding structures exist. Some embodiments provide a unipolar layout, wherein other embodiments provide a bipolar or multipolar layout.

A unipolar layout can denote a layout which provides exactly one magnetic pole if energized with an operating current. The magnetic pole can be provided between the primary winding structure and the secondary winding structure, in particular between horizontal surfaces of the primary and the secondary winding structure. For example, field lines of an electromagnetic field generated by the unipolar winding structure if energized with an operating current do not extend through an area or volume enclosed by another winding structure. In the case of a unipolar winding structure, it is possible that approximately 50% of the field lines extend within a volume between the primary and secondary winding structure, wherein the remaining field lines extend in a free space, i.e. outside the volume. The volume can denote a volume between edges of the primary and secondary winding structure.

In other words, only one section of a closed field line which is generated by an unipolar winding structure extends through an area or volume enclosed by the unipolar winding structure or a subwinding structure of the unipolar winding structure, wherein the remaining portion extends through an area or volume outside said unipolar winding structure. If the unipolar winding structure is a primary-sided winding structure, the remaining portion, however, does not extend through another primary-sided winding structure or subwinding structure. If the unipolar winding structure is a secondary-sided winding structure, the remaining portion, however, does not extend through another secondary-sided winding structure or subwinding structure. This means that a field line returns outside the unipolar winding structure.

Such an unipolar winding structure can e.g. be provided by a single loop or a single coil. An unipolar winding structure, however, can also be provided by a winding structure comprising more than one subwinding structure. If the unipolar winding structure comprises more than one subwinding structure (which will be explained in the following), the directions of orientation of the field lines within the areas or volumes enclosed by the different subwinding structures are equal or substantially equal.

In contrast, a bi- or multipolar layout can denote a layout which provides two or more magnetic poles if energized with an operating current. Again, the magnetic poles can be provided between the primary winding structure and the secondary winding structure, in particular between horizontal surfaces of the primary and the secondary winding structure. For example, field lines of an electromagnetic field generated by a bipolar winding structure if energized with an operating current extend through an area or volume enclosed by a first subwinding structure and through an area or volume enclosed by a further subwinding structure of the bipolar winding structure. In this case, the direction of orientation of the field lines within the area or volume enclosed by the first subwinding structure can be opposite to the direction of orientation of the field lines within the area or volume enclosed by the further subwinding structure. This means that a field line can also return through another subwinding structure. In the case of a multipolar winding structure, it is possible that approximately 90% of the field lines extend within a volume between the primary and secondary winding structure, wherein the remaining field lines extend in a free space, i.e. outside the volume.

An exemplary bipolar winding structure will be explained later. In the case of a multipolar layout, three or even more subwinding structures may exist, wherein field lines which extend through an area or volume enclosed by one of the subwinding structures also extend through an area or volume enclosed by at least one other subwinding structure. If the multipolar winding structure comprises more than one subwinding structure, the direction of orientation of the field lines within the areas or volumes enclosed by the different subwinding structures are different. In particular, the directions of orientations can be oriented opposite to each other.

A secondary winding structure which is provided by one manufacturer does therefore not necessarily cooperate with a primary winding structure provided by another manufacturer. In particular, an inductive power transfer between winding structures of different manufacturers is not possible or an efficiency of said power transfer is reduced. It is therefore desirable to provide a circuit arrangement which can be used within a primary unit and which cooperates with different winding structures of secondary units, e.g. secondary units provided by different manufacturers. It is also desirable to provide a circuit arrangement which can be used within a secondary unit and which cooperates with different winding structures of primary units, e.g. primary units provided by different manufacturers WO 2014/067984 A3 discloses a circuit arrangement, in particular a circuit arrangement of an electric vehicle for inductive power transfer to the vehicle, wherein the circuit arrangement comprises a pick-up arrangement and at least one variable compensating arrangement.

WO 2011/145953 A1 discloses a multiphase IPT primary track conductor arrangement comprising a first phase conductor and a second phase conductor, the conductors being arranged substantially in a plane and so as to overlap each other and being arranged such that there is substantially balanced mutual coupling between the phase conductors. There is the technical problem of providing a circuit arrangement for a primary or secondary unit for inductive power transfer and a method of operating said circuit arrangement which provide an increased operational compatibility with different layouts of the circuit arrangement of the remaining unit for inductive power transfer. The technical problem includes providing a circuit arrangement for a primary unit for inductive power transfer and a method of operating said circuit arrangement which provide an increased operational compatibility with different layouts of the circuit arrangement of the secondary unit. Further the technical problem includes providing a circuit arrangement for a secondary unit for inductive power transfer and a method of operating said circuit arrangement which provide an increased operational compatibility with different layouts of the circuit arrangement of the primary unit. In particular, the technical problem is to provide a winding structure which cooperates with different winding structures, e.g. of different manufactures, in order to transfer power inductively with a maximal efficiency.

The solution to said technical problem is provided by the subject-matter with the features of claims 1 and 12. Further embodiments of the invention are provided by the subject-matter with the features of the sub-claims. A circuit arrangement for a system for inductive power transfer is proposed. The system for inductive power transfer can used to transfer power to a vehicle inductively.

The system for inductive power transfer can comprise a primary unit with the primary winding structure and the secondary unit with a secondary winding structure. Thus, the proposed circuit arrangement can be a circuit arrangement of a primary unit or a secondary unit of the system for inductive power transfer.

The vehicle can comprise the secondary unit with the secondary winding structure for receiving an alternating electromagnetic field which is generated by the primary winding structure of a primary unit. The primary winding structure generates the alternating electromagnetic field if the primary winding structure is energized or supplied with operating currents. The primary unit can comprise a totality or a subset of components by which an alternating electromagnetic field for inductive power transfer is generated. Correspondingly, the secondary unit can comprise a totality or a subset of components by which the alternating electromagnetic field for inductive power transfer is received and a corresponding output voltage is provided.

The primary unit can e.g. be provided by an inductive power transfer pad. An inductive power transfer pad can be installed on the surface of a route or a parking space or it can be integrated within such a surface.

The present invention can be applied in particular to the field of inductive energy transfer to any land vehicle, for example track bound vehicles, such as rail vehicles (e.g. trams). In particular, the invention relates to the field of inductive energy transfer to road automobiles, such as individual (private) passenger cars or public transport vehicles (e.g. busses).

The circuit arrangement can be a primary-sided circuit arrangement or a secondary-sided circuit arrangement. In the context of this invention, the term “secondary-sided” can mean that the respective element is arranged fixed in position relative to a secondary-sided coordinate system. In particular, a position of the secondary-sided element in the secondary-sided coordinate system can be known. Also, the term “secondary-sided” can mean that the respective element can be part of the secondary unit. Correspondingly, the term “primary-sided” can mean that the respective element is arranged fixed in position relative to a primary-sided coordinate system. In particular, a position and/or orientation of the primary-sided element in the primary-sided coordinate system is known. Also, the term “primary-sided” can mean that the respective element is part of the primary unit. In particular, the position and/or orientation of the primary-sided receiving unit in the primary-sided coordinate system and thus relative to the primary winding structure is known.

The circuit arrangement comprises at least one winding structure with a first and at least one other, i.e. further, subwinding structure. A winding structure can be provided by one phase line. A primary unit can e.g. comprise one or more, preferably three, phase lines. In this case, the primary unit can comprise one winding structure per phase line, wherein each winding structure comprises at least two subwinding structures. The winding structure can be provided by one or more conductor(s).

A secondary unit preferably comprises one phase line. It is, however, also possible that the secondary unit comprises more than one phase line.

A subwinding structure can be provided by at least one section of the winding structure. In particular, a subwinding structure can provide a loop or a coil, wherein the loop or coil is provided by at one or multiple section(s) of the winding structure. A loop or coil can be circular-shaped, oval-shaped or rectangular-shaped. Of course, other geometrical shapes are also possible.

The winding structure extends along a longitudinal axis of the winding structure. Preferably, a winding structure comprises two or more subwinding structures which are successively arranged along the longitudinal axis. In this case, successive subwinding structures of the winding structure can be arranged adjacent to one another along said longitudinal axis.

Adjacent to each other can mean that central axes of the subwinding structures, in particular the axes of symmetry, are spaced apart from another, e.g. with a predetermined distance along the longitudinal axis.

The longitudinal axis of a primary winding structure can e.g. be parallel to a desired direction of travel of a vehicle driving above the primary winding structure into a charging position. The longitudinal axis of a secondary winding structure can e.g. be parallel to roll axis of a vehicle to which the secondary unit comprising the secondary winding structure is attached.

The winding structure can, in particular, be provided by flat subwinding structures, in particular flat loops or coils. This means that the winding structure is substantially arranged within a two-dimensional plane. Each subwinding structure can provide one pole of a pole pair of the respective phase line if the winding structure is energized with an alternating current. Two successive subwinding structures can e.g. provide a pole pair. Correspondingly, more than two subwinding structures can provide more poles.

It is possible that a subwinding structure comprises at least one winding section which extends along the longitudinal axis and at least one winding section which extends along a lateral axis. The lateral axis can be oriented orthogonal to the longitudinal axis. The lateral and longitudinal axes can span the aforementioned plane in which the winding structure is substantially arranged. The longitudinal axis and the lateral axis can both be oriented perpendicular to a vertical axis, wherein the vertical axis can be oriented parallel to an axis of symmetry of a subwinding structure and oriented from the primary unit towards a secondary unit. The vertical axis can, in particular, be parallel to the main direction of power transfer. Directional terms referring to a direction such as “above”, “under”, “ahead”, “beside” can relate to the aforementioned longitudinal, lateral and vertical axes.

The winding structure, in particular each subwinding structure, can thus be provided by sections extending substantially or completely parallel to the longitudinal axis and sections extending substantially or completely parallel to the lateral axis. In particular, each subwinding can be provided by two sections extending substantially or completely parallel to the longitudinal axis and two sections extending substantially or completely parallel to the lateral axis. The sections extending parallel to the lateral axis can also be referred to as active sections.

According to the invention, the subwinding structures are operatable in a first operational mode and a second operational mode.

In the first operational mode, an unipolar alternating electromagnetic field is providable by the winding structure. An unipolar alternating electromagnetic field has been defined previously. In the second operational mode, a multipolar electromagnetic field is providable. In particular, a bipolar alternating electromagnetic field can be providable in the second operational mode.

The uni- or multipolar alternating electromagnetic field can e.g. be provided if the winding structure is energized by at least one operating current.

The operating current can denote a current which flows through at least one subwinding structure in order to generate the alternating electromagnetic field, i.e. in the case of a primary winding structure, or upon reception of the alternating electromagnetic field, i.e. in the case of a secondary winding structure. In the latter case, the operating current can be provided by a load current and the alternating electromagnetic field is an opposing electromagnetic field which counteracts the electromagnetic field generated by the primary winding structure. The load current is a current which flows due to induction if a load is connected to the secondary winding structure.

Each subwinding structure can have two connecting terminals. The operating current can e.g. denote the current flowing from the first connecting terminal of the subwinding structure to the second connecting terminal of the subwinding structure.

The first or the second operational mode can be activated, e.g. by a user or automatically. In the case of a primary winding structure, the first and the second operational mode can be activated depending on the layout or operational mode of a secondary winding structure used for inductive power transfer. In the case of a secondary winding structure, the first and the second operational mode can be activated depending on the layout or operational mode of a primary winding structure used for inductive power transfer.

If the winding structure is a primary winding structure, the first operational mode can be activated if the secondary winding structure is a unipolar winding structure. The second operational mode can be activated if the secondary winding structure is a bipolar or multipolar winding structure.

If the winding structure is a secondary winding structure, the first operational mode can be activated if the primary winding structure is a unipolar winding structure. The second operational mode can be activated if the primary winding structure is a bipolar or multipolar winding structure.

It is possible that information on the layout and/or operational mode can be transmitted from the secondary unit to the primary unit or vice versa, e.g. via a communication link. In this case, the first or the second operational mode can be activated depending on the transmitted information.

The circuit arrangement can comprise means for operating the circuit arrangement in the first operational mode or in the second operational mode.

The proposed circuit arrangement advantageously allows an improved operational compatibility with different layouts of winding structures on the other side of the high frequency transformer of the system for inductive power transfer.

If the circuit arrangement is a secondary-sided circuit arrangement, it can e.g. cooperate with an unipolar primary winding structure or a multipolar primary winding structure, wherein the primary winding structure can also be a winding structure of a circuit arrangement according to one of the embodiments described in this invention.

It is further possible that the secondary-sided circuit arrangement cooperates with a three-phase primary unit, a single- or multiphase primary unit with at least one bipolar winding structure, a single- or multiphase primary unit with at least one solenoid winding structure or a single- or multiphase primary unit with at least one loop-shaped winding structure.

A solenoid winding structure can denote a winding structure which is a ferrite rod antenna-like winding structure. In this case, the field lines which extend through the volume or area enclosed by the solenoid winding structure are guided by a magnetic material, e.g. ferrite material. In case of a solenoid winding structure, a normal vector of a surface enclosed by the winding structure can be oriented perpendicular to the main direction of power transfer, e.g. perpendicular to the direction from the primary to the secondary winding structure.

A loop-shaped winding structure, e.g. a circular-shaped, rectangular-shaped or oval-shaped, winding structure can generate field lines which extend from the winding structure and return in a volume outside the winding structure. Such a winding structure can induce a voltage within another loop-shaped winding structure which can be of a smaller, an equal or larger size.

If the circuit arrangement is a primary-sided circuit arrangement, it can e.g. cooperate with an unipolar secondary winding structure or a multipolar secondary winding structure, wherein the secondary winding structure can also be a winding structure of a circuit arrangement according to one of the embodiments described in this invention. It is further possible that the primary-sided circuit arrangement cooperates with a three-phase secondary unit, a single- or multiphase secondary unit with at least one bipolar winding structure, a single- or multiphase secondary unit with at least one solenoid winding structure or a single- or multiphase secondary unit with at least one circular winding structure.

It is possible that mutual coupling between the subwinding structures in the first operational mode is different from the mutual coupling in the second operational mode. In particular, a sign of the mutual coupling can change between the different operational modes. Thus, a resulting inductance of the winding structure can change in different operational modes.

It is possible that the proposed circuit arrangement comprises at least one means for varying an impedance, in particular an inductance, of the winding structure or circuit arrangement. The at least one means for varying the impedance can be controlled such that the impedance of the proposed circuit arrangement in the first operational mode is equal to the impedance in the second operational mode or does not differ more than a predetermined amount from said impedance. Moreover, the impedance can be controlled such that the resulting resonant frequency of the circuit arrangement equals to or does not differ more than a predetermined amount from the operating frequency of the system of inductive power transfer.

Alternatively, the circuit arrangement, in particular the subwinding structures, can be designed and/or arranged such that the mutual inductance between the subwinding structures is equal in the first and in the second operational mode, in particular equal to zero.

In another embodiment, the subwinding structures are operatable such that flow directions of operating currents of successive subwinding structures are oriented in the same direction in the first operational mode, wherein flow directions of operating currents of successive subwinding structures are counter-oriented the second operational mode. The circuit arrangement can comprise means for providing the operating current(s) in the first operational mode or in the second operational mode.

The direction of the current flow can e.g. be a clockwise direction or counter clockwise direction. The clockwise direction can be defined with respect to the parallel central axes of the subwinding structures, wherein these central axes are oriented, e.g. point, into the same direction.

In the first operational mode, the flow direction of the operating currents of all subwinding structure can be oriented clockwise or counter clockwise. In this case, all subwinding structures will generate a magnetic field oriented in the same direction.

In the second operational mode, a flow direction of the operation current in the first subwinding can be oriented clockwise, wherein flow direction of the operating current the other subwinding structure, e.g. the neighbouring or successive subwinding structure, is oriented counter-clockwise or vice versa. In this case, the different subwinding structures will generate a magnetic field oriented in opposite directions.

An operating current can be provided to each subwinding structure or to each subwinding structure of a set of at least two subwinding structures. In other words, each subwinding structure or the set of subwinding structures can be operated by a subwinding- or set-specific operating current. Alternatively, a common operating current can be provided to all subwinding structures. That the operating current is provided to a subwinding structure can mean that the respective subwinding structure is energized by the operating current.

This advantageously allows a simple provision of the unipolar or multipolar alternating electromagnetic field.

In another embodiment, successive subwinding structures along the longitudinal are connectable such the operating currents of successive subwinding structures are oriented in the same direction in the first operational mode, wherein successive subwinding structures are connectable such the operating current of successive subwinding structures is counter-oriented the second operational mode.

In this embodiment, subwinding structures, in particular successive subwinding structures, can be electrically connectable to one another. In this case, the same operating current can be provided to successive or all subwinding structures. Two connecting states can exist. In a first connecting state which can be provided e.g. in the first operational mode, a second terminal of the first subwinding structure can be connected to a first terminal of the other, e.g. successive, subwinding structure. In a second connecting state which can be provided e.g. in the second operational mode, a second terminal of the first subwinding structure can be connected to a second terminal of the other, e.g. successive, subwinding structure. If the winding structure is a primary winding structure, the common operating current can e.g. be provided by one inverter.

The circuit arrangement can comprise means, e.g. switches, for connecting the subwinding structures in the first operational mode or in the second operational mode, i.e. in the first and in the second connecting state.

This advantageously allows to provide alternating electromagnetic fields with different polarities with a simple setup.

In an alternative embodiment, an operating current for one subwinding structure of at least two successive subwinding structures is providable independent of an operating current of the remaining subwinding structure. In this embodiment, subwinding structures, in particular successive subwinding structures, are not electrically connected to one another. In this case, independent operating currents can be provided to successive or all subwinding structures. If the winding structure is a primary winding structure, the different operating currents can e.g. be provided by different inverters. This advantageously increases a flexibility of the operation of different subwinding structures.

In another embodiment, the circuit arrangement comprises at least one inverter, wherein AC output terminals of the at least one inverter are connected to terminals of at least one subwinding structure or to terminals of connectable subwinding structures. This embodiment provides, in particular, a primary-sided circuit arrangement.

If multiple or all subwinding structures are connectable, a first output terminal of the inverter can be connected to a terminal of a first subwinding structure, wherein the second output terminal of the inverter can be connected to a terminal of the (electrically) last subwinding structure of the set of connectable subwinding structures.

In another embodiment, the circuit arrangement comprises at least two inverters, wherein AC output terminals of a first inverter are connected to terminals of a first subwinding structure or to terminals of first set of connectable subwinding structures or to terminals of each subwinding structure of a first set of subwinding structures, wherein AC output terminals of a second inverter are connected to terminals of a second subwinding structure or two terminals of a second set of connectable subwinding structures or to terminals of each subwinding structure of a second set of subwinding structures.

It is possible that an AC output terminal of the first inverter is electrically connected to one output terminal of the second inverter. In this case, a subwinding structure of the first set and a subwinding structure of the second set can have a common section.

The first and the second set can comprise different subwinding structures. Successive subwinding structures along the direction of extension of the winding structure can be assigned to different sets of subwinding structures. The subwinding structures of one set of subwinding structures can be connected in parallel or in series. If a set comprises multiple connectable subwinding structures, a first output terminal of the inverter can be connected to a terminal of first subwinding structure of said set, wherein the second output terminal of the inverter can be connected to a terminal of the (electrically) last subwinding structure of said set.

Subwinding structures of the first and the second set can be arranged in an alternating sequence along the direction of extension of the winding structure. This means that the successive subwinding structure is provided by a subwinding structure of the other set of subwinding structures. This advantageously allows a simple generation of a multipolar alternating electromagnetic field.

In another embodiment, the circuit arrangement comprises one inverter per subwinding structure, wherein AC output terminals of one inverter are connected to terminals of one subwinding structure. In this case, each subwinding structure can be operated by a subwinding-specific inverter.

In another embodiment, DC input terminals of the at least two inverters are connected in parallel. This advantageously provides a simple and space-saving implementation of a circuit arrangement with at least two inverters.

In another embodiment, the circuit arrangement comprises at least one filter element. The circuit arrangement can comprises one filter element per subwinding structure or one filter element per set of subwinding structures. The filter element can comprise an inductive and a capacitive element, e.g. an inductor and a capacitor. The filter element can provide a low-pass filter. The inverter can be connected to the subwinding structure or set of subwinding structures via the filter element.

This advantageously provides an EMC filtering and allows to adapt the winding structure to the grid connection.

In another embodiment, the circuit arrangement comprises at least one variable compensating arrangement. The circuit arrangement can comprises one variable compensating arrangement per subwinding structure or one variable compensating arrangement per set of subwinding structures. The inverter can be connected to the subwinding structure or set of subwinding structures via the variable compensating arrangement.

Such a compensating arrangement and a method of operating such a compensation arrangement is described in WO 2014/067984 A3. The disclosure of WO 2014/067984 A3 is fully incorporated by reference.

In particular, the variable compensating arrangement can comprises a capacitive element. Further, the variable compensating arrangement can comprise a first switching element and a second switching element, wherein the first switching element and the second switching element are connected in series, wherein the series connection of the first and the second switching element is connected in parallel to the capacitive element of the variable compensating arrangement. Alternatively, the variable compensating arrangement can comprise a first switching element, a second switching element and a further capacitive element, wherein the first switching element, the second switching element and the further capacitive element are connected in series, wherein the series connection of the first switching element, the second switching element and the further capacitive element is connected in parallel to the capacitive element of the variable compensating arrangement.

Further, the first switching element and/or the second switching element can be (a) semiconductor element(s). Further, the first switching element has a conducting direction and the second switching element has a conducting direction, wherein the first and the second switching element are connected such that the conducting direction of the first switching element is opposite to the conducting direction of the second switching element. Further, a first diode is connected anti-parallel to the first switching element and a second diode is connected anti-parallel to the second switching element.

Further, the circuit arrangement can comprise a least one current sensing means for sensing a phase current of the circuit arrangement, wherein switching times of the first and the second switching element are controllable depending on the phase current. Further, the circuit arrangement can comprise a least one voltage sensing means for sensing a voltage across the capacitive element of the variable compensating arrangement, wherein the switching times of the first and the second switching element are controllable depending on the voltage.

The variable compensating arrangement provides a so-called tuning circuit or can be a part of a tuning circuit. By controlling the operating mode of the switching elements, an impedance of the variable compensating arrangement can be varied. Thus, the overall or resulting impedance of the circuit arrangement can be varied.

To summarize, the variable compensating arrangement provides a variable capacitance which can be adjusted by controlling the operating mode of the switching elements. The proposed circuit arrangement therefore advantageously allows adjusting an impedance of the circuit arrangement by adjusting the variable capacitance of the variable compensating arrangement. Thus, the impedance of the proposed circuit arrangement can be adjusted such that a resonant frequency of the circuit arrangement is equal to a predetermined operating frequency. Also, a compensation of the change of inductance of the winding structure if the operational mode is switched from the first to the second operational mode or vice versa can be provided. In particular, the variable compensating arrangement can be controlled such that the impedance of the proposed circuit arrangement in the first operational mode is equal to the impedance in the second operational mode or does not differ more than a predetermined amount from said impedance.

Further, a detuning of the circuit arrangement subject to e.g. temperature changes and/or aging can be compensated for.

In another embodiment, the circuit arrangement comprises at least one magnetically conducting element or an arrangement of magnetically conducting elements. The magnetically conducting element can also be referred to as flux guiding element. The flux guiding element is used to guide a magnetic flux of the electromagnetic field which is generated by the primary-sided arrangement. The magnetically conducting element can e.g. be a ferrite element or can comprise one or multiple ferrite element(s).

The at least one magnetically conducting element can be arranged under a primary-sided winding structure or above a secondary-sided winding structure. In this case, the at least one magnetically conducting element can be arranged under/above one, selected or all subwinding structures. Alternatively or in addition, the at least one magnetically conducting element or one element of the arrangement of multiple elements can be arranged at least partially within the plane in which the winding structure is arranged. In particular, the at least one magnetically conducting element can extend into a volume or area enclosed by one subwinding structure.

The at least one magnetically conducting element or the arrangement of multiple elements can extend along the longitudinal axis. In particular, the at least one magnetically conducting element can be a strip-like or elongated element. This advantageously allows decreasing the magnetic flux extending away from the primary-sided arrangement in an unwanted direction.

Further, the arrangement of magnetically conducting elements can comprise multiple bar elements. These bar elements can be arranged such that the bar elements extend along the longitudinal axis. Multiple bar elements can be arranged along or parallel to a straight line parallel to the longitudinal axis, wherein these multiple bar elements can abut or overlap at front end or rear sections of the bar elements. Such an arrangement can also be referred to as row of bar elements. It is possible that the arrangement of multiple bar elements comprises multiple rows, wherein each row comprises one or multiple bar elements.

Further, the arrangement of magnetically conducting elements can comprise multiple rows of at least one bar element, wherein a non-zero gap between two adjacent rows is provided along the lateral direction. Each row comprises one or multiple bar elements extending along a line parallel to the longitudinal axis. The rows are spaced apart from another along or parallel to the lateral axis.

Further, at least two bar elements can overlap each other. In particular, the at least two bar elements can overlap each other at a front end or rear end section of the bar elements. More particular, two adjacent bar elements of one row of multiple bar elements can overlap. This can mean that the at least two bar elements are arranged at different vertical positions along the aforementioned vertical axis.

Further, the least one magnetically conducting element or an arrangement of magnetically conducting elements can provide a recess to receive at least a section of a winding structure. In particular, the recess can be arranged and/or designed in order to receive a section of a winding structure extending along or parallel to the lateral axis. More particular, the recess can be designed and/or arranged such that a section of a winding structure at the transition from one subwinding structure to the successive subwinding structure along the longitudinal axis can be arranged within the recess. This advantageously further reduces an installation space requirement.

Further, at least one section of at least one magnetically conductive element can extend into one subwinding structure. This can mean that the at least one section extends into a volume or area enclosed by the subwinding structure. This advantageously further reduces an installation space requirement.

Further proposed is a method of operating a circuit arrangement for a system for inductive power transfer. The circuit arrangement can be a circuit arrangement according to one of the embodiments described in this invention. Thus, the circuit arrangement can be designed such that the method according to one of the embodiments described in this invention can be performed by the circuit arrangement.

The circuit arrangement can be operated in a first operational mode or in a second operational mode. In a first operational mode, the subwinding structures are operated such that an unipolar alternating electromagnetic field is provided. In the second operational mode, the subwinding structures are operated such that a multipolar electromagnetic field is provided. The alternating electromagnetic field can be generated by an operating current or an induced current.

The operational mode can be selected depending on the layout or operational mode of the winding structure of the other side of the aforementioned transformer. This has been explained before.

In another embodiment, flow directions of operating currents of successive subwinding structures are oriented in the same direction in the first operational mode, wherein flow directions of operating currents of successive subwinding structures are counter-oriented the second operational mode. The operating current can be provided individually for each subwinding structure. Alternatively, a common operating current can be provided for selected or all subwinding structures. This has been explained before.

In another embodiment, successive subwinding structures are connected such that flow directions of operating currents of successive subwinding structures are oriented in the same direction in the first operational mode, wherein successive subwinding structures are connected such that flow directions of the operating currents of successive subwinding structures is counter-oriented the second operational mode. In this case, one common operating current can be provided to all subwinding structures. This has been explained before.

In an alternative embodiment, an operating current for one winding structure of at least two successive subwinding structures is provided independent of an operating current of the remaining winding structure. This has been explained before. In this case, the winding structures can be electrically isolated from one another.

In another embodiment, an operating current for at least one subwinding structure is provided by an inverter. This has been explained before.

In another embodiment, the operating current for a first subwinding structure or for a first set of connected subwinding structures or for each subwinding structure of a first set of subwinding structures is provided by a first inverter, wherein an operating current for a second subwinding structure or for a second set of connected subwinding structures or for each subwinding structure of a second set of subwinding structures is provided by another inverter. This has been explained before.

In another embodiment, the operating current of each subwinding structure is provided by another inverter. This has been explained before.

Further described is a primary unit of a system for inductive power transfer, wherein the primary unit comprises a circuit arrangement according to one of the embodiments described in this invention.

Further described is a secondary unit of a system for inductive power transfer, wherein the secondary unit comprises a circuit arrangement according to one of the embodiments described in this invention.

The invention will be described with reference to exemplary embodiments of the invention which are illustrated by the following figures. The figures show:

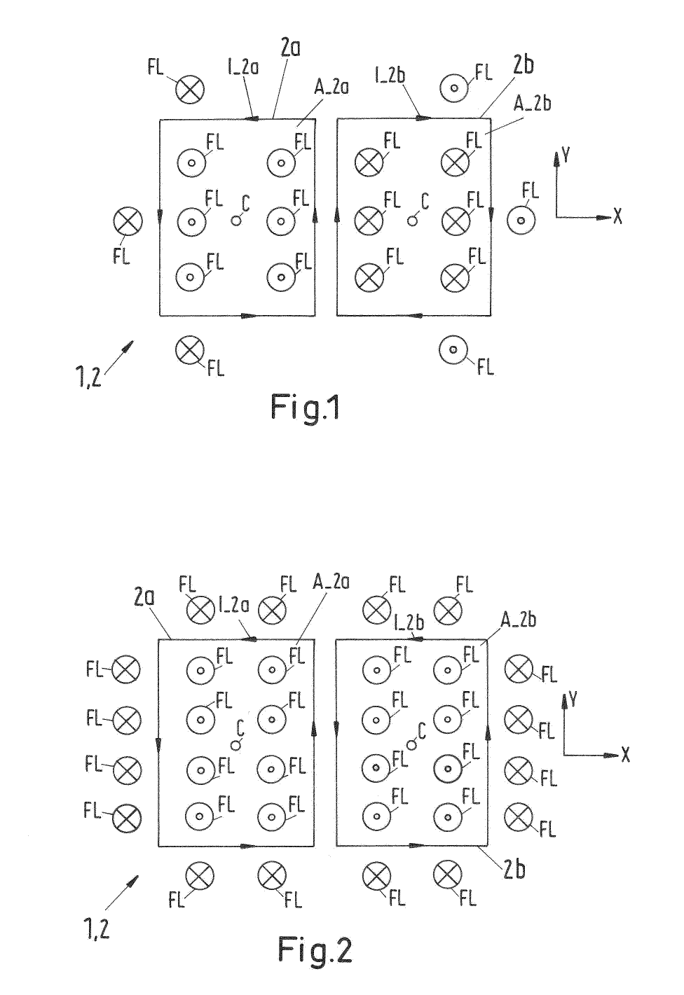

FIG. 1: a schematic top view on a circuit arrangement with two subwinding structures in a second operational mode,

FIG. 2: a schematic top view on a circuit arrangement with two subwinding structures in a first operational mode, and

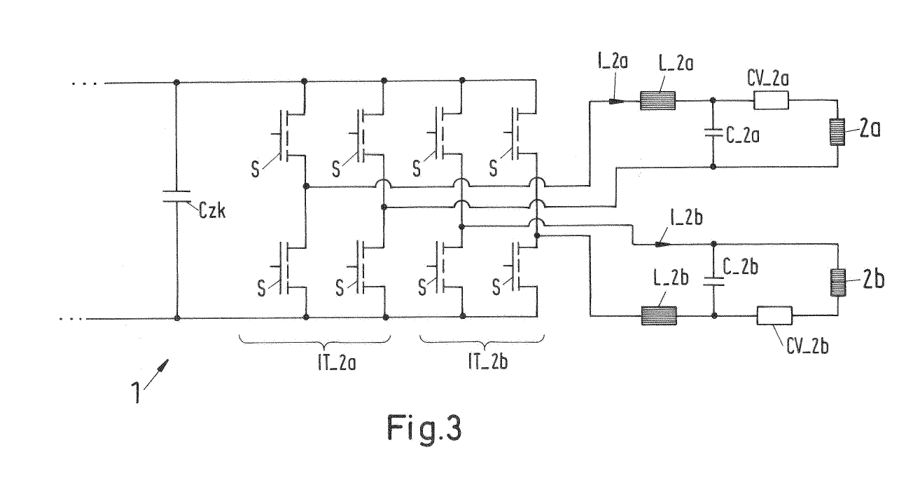

FIG. 3: a schematic circuit diagram of a circuit arrangement with two subwinding structures.

In the following, identical reference numerals denote elements with the same or similar technical features.

FIG. 1 shows a schematic top view on a circuit arrangement 1 with a winding structure 2 in a second operational mode. The winding structure 2 comprises a first sub-winding 2a and a second sub-winding 2b. This subwinding structures 2a, 2b can be electrically connectable or can be electrically isolated from one another. The first and the second sub-winding 2a, 2b have a rectangular shape. This is, however, not a mandatory design. Each of the first and the second subwinding 2a, 2b provides a coil, wherein a number of turns is equal to one or higher. The first subwinding structure 2a encloses a first inner area A_2a. The second subwinding structure 2b encloses a second inner area A_2b.

Further shown is a longitudinal axis x which is oriented parallel to a longitudinal axis of the winding structure 2. The longitudinal axis x connects geometric centres C of each sub-winding 2a, 2b. A vertical axis (not shown) is oriented perpendicular to the plane of projection and points towards an observer. Further indicated is a lateral axis y which is oriented perpendicular to the longitudinal axis x and the vertical axis. The lateral axis y can be oriented parallel to a lateral axis of the winding structure 2.

The subwinding structures 2a, 2b are successive subwinding structure 2a, 2b along the longitudinal axis x.

Further indicated is an operating current I_2a of the first subwinding structure 2a and an operating current I_2b of the second subwinding structure 2b. The corresponding flow direction is indicated by an arrow.

In FIG. 1, the flow direction of the operating current I_2a of the first subwinding structure 2a is opposite to the flow direction of the operating current I_2b of the second subwinding structure 2b. In particular, the flow direction of the operating current I_2a of the first subwinding structure 2a corresponds to a counter-clockwise direction, wherein the flow direction of the operating current I_2b of the second subwinding structure 2b corresponds to a clockwise direction. The flow direction denotes a direction of rotation with respect to the centrelines of each subwinding structure 2a, 2b which extend through the respective geometric centre C and are oriented parallel to the aforementioned vertical axis. In FIG. 1, the flow direction corresponds to a counter-clockwise direction with respect to the respective centrelines.

Further indicated are field lines FL of an alternating electromagnetic field which is generated by the subwinding structures 2a, 2b if the operating currents I_2a, I_2b are provided as shown in FIG. 1. Field lines FL with a dot indicate field lines which are oriented towards the observer, wherein field lines FL with a cross indicate field lines which are oriented away from the observer.

It is shown that the field lines FL which intersect the first inner area A_2a are oriented in an opposite direction as the field lines FL which intersect the second inner are A_2b. The circuit arrangement 1 shown in FIG. 1 is operated in a second operational mode and provides a bipolar alternating electromagnetic field.

FIG. 2 shows a schematic top view on a circuit arrangement 1 with a winding structure 2 in a first operational mode. The circuit arrangement 1 shown in FIG. 2 is designed as the circuit arrangement 1 shown in FIG. 1. In contrast to the embodiment shown in FIG. 1, the flow direction of the operating current I_2a of the first subwinding structure 2a is equal to the flow direction of the operating current I_2b of the second subwinding structure 2b. In particular, the flow direction of the operating current I_2a of the first and second subwinding structure 2a, 2b corresponds to a counter-clockwise direction. The current I_2a and the current I_2b in neutralize each other in the adjacent section of the subwinding structures 2a, 2b.

It is shown that the field lines FL which intersect the first inner area A_2a are oriented in the same direction as the field lines FL which intersect the second inner are A_2b. The circuit arrangement 1 shown in FIG. 2 is operated in a first operational mode and provides a unipolar alternating electromagnetic field.

It is possible that the subwinding structures 2a, 2b shown in FIG. 1 and FIG. 2 are connected such that the shown flow directions of the operating currents I_2a, I_2b is provided, wherein the operating current I_2a provides the operating current I_2b. Alternatively, the operating currents I_2a, I_2b can be provided independently to or by each subwinding structure 2a, 2b such the shown flow directions of the operating currents I_2a, I_2b are provided.

FIG. 3 shows a schematic circuit diagram of a circuit arrangement 1 with two subwinding structures 2a, 2b. The circuit arrangement 1 comprises two inverters IT_2a, IT_2b, wherein DC terminals of the inverters IT_2a, IT_2b are connected in parallel to an intermediate circuit capacitor Czk. The first inverter IT_2a provides an operating current I_2a for the first subwinding structure 2a, wherein the second inverter IT_2b provides an operating current I_2b for the second subwinding structure 2b. AC terminals of the first inverter IT_2a are connected to an arrangement comprising a filter element, a variable compensating element CV_2a and the first subwinding structure 2a. The filter element comprises an inductive element L_2a and a capacitive element C_2a. The filter element, the variable compensating element CV_2a and the first subwinding structure 2a are connected in series. Correspondingly, AC terminals of the second inverter IT_2b are connected to an arrangement comprising a filter element, a variable compensating element CV_2b and the second subwinding structure 2b. The filter element comprises an inductive element L_2b and a capacitive element C_2b. The filter element, the variable compensating element CV_2b and the first subwinding structure 2b are connected in series.

Each inverter IT1, IT2 comprises two switching legs which are arranged in parallel. Each switching leg comprises two switching elements S connected in series. By adjusting the switching times or pulse width of the switching elements S, a desired operating current I_2a, I_2b can be provided. The switching times or pulse width can e.g. be adjusted by a control unit (not shown).

1.-18. (canceled)

19. A circuit arrangement for a system for inductive power transfer to a vehicle, wherein the circuit arrangement comprises at least one winding structure with a first and at least one other subwinding structure,
wherein the subwinding structures are operatable in a first operational mode and a second operational mode, wherein an unipolar alternating electromagnetic field is providable in the first operational mode and a multipolar electromagnetic field is providable in the second operational mode,
wherein
successive subwinding structures are connectable such the operating currents of successive subwinding structures are oriented in the same direction in the first operational mode, wherein successive subwinding structures are connectable such the operating currents of successive subwinding structures are counter-oriented the second operational mode.

20. The circuit arrangement according to claim 19, wherein the subwinding structures are operatable such that flow directions of operating currents of successive subwinding structures are oriented in the same direction in the first operational mode, wherein flow directions of operating currents of successive subwinding structures are counter-oriented the second operational mode.

21. The circuit arrangement of claim 19, wherein the circuit arrangement comprises at least one inverter, wherein AC output terminals of the at least one inverter are connected to terminals of at least one subwinding structure or to terminals of connectable subwinding structures.

22. The circuit arrangement of claim 21, wherein the circuit arrangement comprises at least two inverters, wherein AC output terminals of a first inverter are connected to terminals of a first subwinding structure or to terminals of a first set of connectable subwinding structures or to terminals of each subwinding structure of a first set of subwinding structures, wherein AC output terminals of a second inverter are connected to terminals of a second subwinding structure or to terminals of a second set of connectable subwinding structures or to terminals of each subwinding structure of a second set of subwinding structures.

23. The circuit arrangement of claim 22, wherein the circuit arrangement comprises one inverter per subwinding structure, wherein AC output terminals of one inverter are connected to terminals of one subwinding structure.

24. The circuit arrangement of claim 21, wherein DC input terminals of the at least two inverters are connected in parallel.

25. The circuit arrangement of claim 19, wherein the circuit arrangement comprises at least one filter element.

26. The circuit arrangement of claim 19, wherein the circuit arrangement comprises a least one variable compensating element.

27. The circuit arrangement of claim 19, wherein the circuit arrangement comprises at least one magnetically conducting element or an arrangement of magnetically conducting elements.

28. A method for operating a circuit arrangement for a system for inductive power transfer to a vehicle, wherein the circuit arrangement comprises at least one winding structure with a first and at least one other subwinding structure,
wherein successive subwinding structures are connectable such the operating currents of successive subwinding structures are oriented in the same direction in the first operational mode, wherein successive subwinding structures are connectable such the operating currents of successive subwinding structures are counter-oriented the second operational mode;
operating the subwinding structures such that an unipolar alternating electromagnetic field is provided if the subwinding structures are operated in a first operational mode; or
operating the subwinding structures such that a multipolar electromagnetic field is provided if the subwinding structures are operated in a second operational mode.

29. The method of claim 28, wherein flow directions of operating currents of successive subwinding structures are oriented in the same direction in the first operational mode, wherein flow directions of operating currents of successive subwinding structures are counter-oriented the second operational mode.

30. The method of claim 28, wherein successive subwinding structures are connected such that flow directions of operating currents of successive subwinding structures are oriented in the same direction in the first operational mode, wherein successive subwinding structures are connected such that flow directions of operating currents of successive subwinding structures are counter-oriented the second operational mode.

31. The method of claim 28, wherein an operating current for one winding structure of at least two successive subwinding structures is provided independent of an operating current of the remaining winding structure.

32. The method of claim 28, wherein an operating current for at least one subwinding structure is provided by an inverter.

33. The method of claim 32, wherein the operating current for a first subwinding structure or for a first set of connected subwinding structures or for each subwinding structure of a first set of subwinding structures is provided by a first inverter, wherein an operating current for a second subwinding structure or for a second set of connected subwinding structures or for each subwinding structure of a second set of subwinding structures is provided by another inverter.

34. The method of claim 32, wherein the operating current of each subwinding structure is provided by another inverter.
